(19) United States
(12) Patent Application Publication
(10) Pub. No.: US 2010/0203213 A1
(43) Pub. Date: Aug. 12, 2010

(54) ANTIOXIDATIVE AND ANTIMICROBIOLOGICAL PROTECTION OF FATS AND FOODSTUFFS CONTAINING FATS WITH A MIXTURE OF LABIATAE AND GREEN TEA EXTRACTS

(76) Inventors: Majda Hadolin Kolar, Zetale (SI); Simona Urbancic, Ptuj (SI)

Correspondence Address: Pearl Cohen Zedek Latzer, LLP, 1500 Broadway, 12th Floor, New York, NY, 10036, US

(21) Appl. No.: 12/679,707

(22) PCT Filed: Jul. 31, 2008
(86) PCT No.: PCT/IB08/01995

§ 371 Date: Mar. 24, 2010

(30) Foreign Application Priority Data
Oct. 4, 2007 (SI) P*200700246

(51) Int. Cl. C11B 5/00; A23D 9/06

(52) U.S. Cl. 426/541

(57) ABSTRACT

The antioxidative and microbialogical protection of fats and foodstuff comprising fats, such as, meat, meat products, fish and fish products, is achieved by the addition of a mixture, based on the extract of at least one plant from the Labiatae family and green tea extract, wherein the mixture has synergistic effect to the fats/foodstuff comprising fats. The active substances in the mixture may be carnosic acid, rosmarinic acid and epigallocatechin-gallate. The mixture may comprise 0 to 50% of each of those substances, wherein the amount of the existing substances in the final product is at least 1 ppm.

### FIELD OF THE INVENTION

This invention relates to the antioxidative and microbiological protection of fats and foodstuffs containing fats, especially meat and meat products, as well as fish and fish products. More specifically, this invention relates to the protection of the color, texture, flavor and odor of fats, and antimicrobial protection of fats and foodstuff comprising fats, by means of a mixture of an extract made of plants chosen from the Labiatae family, and green tea extract having a synergistic effect.

### BACKGROUND OF THE INVENTION

The Labiatae family includes rosemary, sage, melissa, oregano, savory, mint, thyme and others. The main active substances in the extracts of the plants of the Labiatae family are carnosic acid, carnosol, rosemary acid, and derivatives thereof. Carnosic acid and carnosol are oil-soluble, and rosmarinic acid is a water-soluble active substance. The oil-soluble extract of the plants of the Labiatae family contains from 0 to 100% (w/w) of carnosic acid and from 0 to 20% (w/w) of carnosol, while the water-soluble extract of the plants of the Labiatae family contains from 0 to 100% (w/w) of rosmarinic acid. The main antioxidative active substances in green tea extract are epicatechin, epicatechin-gallate, epigallocatechin and epigallocatechin-gallate. The most potent antioxidant is epigallocatechin-gallate. The green tea extract contains from 0 to 100% (w/w) of epigallocatechin-gallate.

As well known in the art, fats, as well as fat comprising foodstuff, in particular, meat and fish and products thereof are susceptible to microbiological deterioration and fats oxidation, which is evident from the changes in flavor, odor and color. Further, a loss of the nutritional value of such foodstuff is also documented when microbiological deterioration and fat oxidation take place. In the art, in addition to heating methods, the deterioration processes are inhibited, or at least retarded by the addition of antioxidative and/or microbiological agents, such as various synthetic additives, ascorbic acid and its salts, isoascorbic acid and its salts, sodium acetate, lactates and others into the food.

However, since most additives are synthetic, which may cause health problems, there is a need in the art for a natural preservative to preserve fats, as well as foodstuff comprising fats, wherein there will be no health hazards, and where the properties of the food, e.g, flavor and coloring, will not be impaired by the additive.

### SUMMARY OF THE INVENTION

It is the object of the invention to provide means for the antioxidative and microbiological protection of fat and foodstuff comprising fat.

It is a further object of the invention that the fat and foodstuff comprising fat may be protected while not changing the color, texture, flavor and odor of the products.

In an embodiment of the invention, there is provided a mixture for the antioxidative and microbiological protection of fats and foodstuffs comprising fats, wherein the mixture comprises the extract of at least one plant chosen from the Labiatae family, and green tea extract having a synergistic effect.

In an embodiment of the invention, there is provided a method for protecting fats and foodstuffs from oxidation comprising fats by contacting the foodstuff with a mixture comprising an extract of at least one plant chosen from the Labiatae family, and a green tea extract, wherein the at least one plant chosen from the Labiatae family, and green tea extract has a synergistic effect.

In an embodiment of the invention, there is provided a method for protecting food and foodstuffs from microbes comprising by contacting the foodstuff with a mixture comprising an extract of at least one plant chosen from the Labiatae family, and a green tea extract, wherein the at least one plant chosen from the Labiatae family, and green tea extract has a synergistic effect.

All the above and other characteristics and advantages of the invention will be further understood through the following illustrative and non-limitative detailed description thereof.

### BRIEF DESCRIPTION OF THE DRAWINGS

The present invention will be understood and appreciated more fully from the detailed description taken in conjunction with the drawings in which:

FIG. 1 describes the results of a Rancimat test of the fat from fresh ground beef meat supplemented with synthetic antioxidants ascorbic acid and sodium ascorbate, in a concentration of 0.05%, rosemary extract in a concentration of 20 mg/kg carnosic acid, green tea extract in a concentration of 50 mg/kg epigallocatechin-gallate, a synergistic mixture based on rosemary and green tea extracts (MIXTURE 1), in a concentration of 20 mg/kg of carnosic acid, and 50 mg/kg of epigallocatechin-gallate, and without antioxidants (CONTROL), after storage for five days at a temperature of 2° C.

FIG. 2 describes the results of measuring the TBA number of fresh ground beef meat supplemented with synthetic antioxidants ascorbic acid and sodium ascorbate, in a concentration of 0.05%, rosemary extract in a concentration of 20 mg/kg of carnosic acid, green tea extract in a concentration of 50 mg/kg of epigallocatechin-gallate, a synergistic mixture based on rosemary and green tea extracts (MIXTURE 1), in a concentration of 20 mg/kg of carnosic acid, and 50 mg/kg of epigallocatechin-gallate, and without antioxidants (CONTROL), after storage for five days at a temperature of 2° C.

FIG. 3 describes the results of microbiological evaluation of fresh ground beef meat supplemented with synthetic antioxidants ascorbic acid and sodium ascorbate, in a concentration of 0.05%, rosemary extract in a concentration of 20 mg/kg of carnosic acid, green tea extract in a concentration of 50 mg/kg of epigallocatechin.gallate, a synergistic mixture based on rosemary and green tea extracts (MIXTURE 1), in a concentration of 20 mg/kg of carnosic acid, and 50 mg/kg of epigallocatechin-gallate, and without antioxidants (CONTROL), after storage for three days at a temperature of 2° C.

FIG. 4 describes the results of microbiological evaluation of fresh ground beef meat supplemented with synthetic antioxidants ascorbic acid and sodium ascorbate, in a concentration of 0.05%, rosemary extract in a concentration of 20 mg/kg of carnosic acid, green tea extract in a concentration of 50 mg/kg of epigallocatechin.gallate, a synergistic mixture based on rosemary and green tea extracts (MIXTURE 1), in a concentration of 20 mg/kg of carnosic acid, and 50 mg/kg of epigallocatechin-gallate, and without antioxidants (CONTROL), after storage for five days at a temperature of 2° C.

FIG. 5 describes the results of Rancimat test of the fat from dried salami sausage supplemented with synthetic antioxidants ascorbic acid and sodium ascorbate, in a concentration of 0.05%, rosemary extract in a concentration of 20 mg/kg camosic acid, green tea extract in a concentration of 50 mg/kg epigallocatechin-gallate, a synergistic mixture based on rosemary and green tea extracts (MIXTURE 1), in a concentration of 20 mg/kg of carnosic acid, and 50 mg/kg of epigallocatechin-gallate, and without antioxidants (CONTROL), after storage for 150 days at a temperature of 4° C.

FIG. 6 describes the results of measuring the TBA number of dried salami sausage supplemented with synthetic antioxidants ascorbic acid and sodium ascorbate, in a concentration of 0.05%, rosemary extract in a concentration of 20 mg/kg of carnosic acid, green tea extract in a concentration of 50 mg/kg of epigallocatechin.gallate, a synergistic mixture based on rosemary and green tea extracts (MIXTURE 1), in a concentration of 20 mg/kg of carnosic acid, and 50 mg/kg of epigallocatechin-gallate, and without antioxidants (CONTROL), after storage for 150 days at a temperature of 4° C.

FIG. 7 describes the results of microbiological evaluation of dried salami sausage supplemented with synthetic antioxidants ascorbic acid and sodium ascorbate, in a concentration of 0.05%, rosemary extract in a concentration of 20 mg/kg of carnosic acid, green tea extract in a concentration of 50 mg/kg of epigallocatechin.gallate, a synergistic mixture based on rosemary and green tea extracts (MIXTURE 1), in a concentration of 20 mg/kg of carnosic acid, and 50 mg/kg of epigallocatechin-gallate, and without antioxidants (CONTROL), after storage for 150 days at a temperature of 4° C.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

It is understood within the scope of this invention, that “meat” encompasses all sorts of fresh meat, and “products” all meat products. It is understood as well, that “fish” encompasses all fish types, and “fish products” all products made of fish.

In an embodiment of the invention, the “meat or fish products” may be any of the following meat and meat products (fresh meat, fresh spiced meat, fresh sausages, mortadella type sausages, parisien type sausages, blood sausages, hot dog type sausages, cooked sausages, salamis, dry cured products, cooked cured products, pastrami and more), fish and fish products, pate type meat and fish products, fast food, thermally processed foods and pre-prepared food (frozen, shelf-stable, refrigerated)

This invention discloses an alternative to synthetic agents, wherein natural antioxidative and/or antimicrobial agents are used. These natural agents are endowed with the following advantages: application in conformance with the quantum satis principle, 100% natural, and comply with the GRAS status.

This invention is directed to the protection of fats and foodstuff comprising fats by means of a mixture based on the extract made of plants chosen from the Labiatae family, and green tea extract. The main active substances in the extracts of the plants of the Labiatae family are carnosic acid, carnosol, rosmarinic acid, and derivatives thereof. They act antioxidatively as hydrogen atom donors. The main antioxidative active substances in green tea extract are epicatechin, epicatechin-gallate, epigallocatechin and epigallocatechin-gallate. Green tea catechins act by effectively inhibiting alkoxyl radicals that are formed as precursors of aldehydes. In an embodiment of the invention, the mixture's components have synergistic fat protecting effect.

Thus, this invention is directed to a mixture comprising the extract of at least one plant from the Labiatae family, and green tea extract. In an embodiment of the invention the mixture's components have a synergistic fat protecting effect.

According to the invention, the foodstuff comprising fat may be meat, meat products, fish, and fish products.

According to one embodiment of the invention, the synergistic mixture contains from 0 to 50% of carnosic acid and/or from 0 to 50% of rosmarinic acid, and from 0 to 50% of epigallocatechin-gallate.

In an embodiment of the invention, the ratio between the concentrations of the active components in the mixture is 2% (w/w) of carnosic acid and/or rosmarinic acid and 5% (w/w) of epigallocatechin-gallate.

In another embodiment of the invention, the ratio between the concentrations of the active components in the mixture is 1% (w/w) of carnosic acid and/or rosmarinic acid and 2% (w/w) of epigallocatechin-gallate.

In another embodiment the ratio between the concentrations of the active components in the mixture is 1% (w/w) of carnosic acid and/or rosmarinic acid and 3% (w/w) of epigallocatechin-gallate.

In another embodiment the ratio between the concentrations of the active components in the mixture is 1% (w/w) of carnosic acid and/or rosmarinic acid and 4% (w/w) of epigallocatechin-gallate.

Another embodiment the ratio between the concentrations of the active components in the mixture is 2% (w/w) of carnosic acid and/or rosmarinic acid and 1% (w/w) of epigallocatechin-gallate.

According to a further embodiment of the invention, the synergistic mixture may comprise also edible salt, maltodextrin, dextrose, and other carriers or emulsifiers allowed in food processing industry, as well as any distribution enhancers, such as without any limitation silicone dioxide.

According to the invention, the foodstuff, e.g., meat and meat products, and fish and fish products, supplemented by the said synergistic mixture of this invention retain their bright pink color, texture, flavor and fresh odor

According to one embodiment of the invention, the synergistic mixture is added to the fat/fat containing foodstuff, in such a concentration that the concentration of carnosic acid and/or rosemary acid and epigallocatechin-gallate in the final product is at least 1 ppm (mg/kg).

In an embodiment of the invention, there is provided a method for protecting fats and foodstuffs from oxidation comprising fats by adding a mixture comprising an extract of at least one plant chosen from the Labiatae family, and a green tea extract, wherein the at least one plant chosen from the Labiatae family, and green tea extract has a synergistic effect.

In an embodiment of the invention, there is provided a method for protecting fats and foodstuffs from microbes comprising food by adding a mixture comprising an extract of at least one plant chosen from the Labiatae family, and a green tea extract, wherein the at least one plant chosen from the Labiatae family, and green tea extract has a synergistic effect.

The invention is further directed to fats and foodstuff comprising fats, comprising a synergistic mixture of the extract of at least one plant chosen from the Labiatae family, and green tea extract.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

The invention will be further illustrated with reference to the following illustrative examples, which are not intended to limit the scope of the invention in any manner.

### Examples

### Experimental Procedures

### Rancimat Test

The Rancimat test measures the conductivity of low molecular weight fatty acids produced during autoxidation of fats. The oxidative stability was determined by Rancimat test at 100° C. Results are presented as a function of induction time. Higher induction time indicates better oxidative stability of the product.

### TBA Test

The TBA test is a method for determination of lipid peroxidation in meat products. The

TBA test quantitatively determines the amount of an end product of lipid oxidation, malondialdehyde (MDA), reacting with thiobarbituric acid (TBA) so as to produce a red pigment with a fixed absorption spectrum. Results are presented as a TBA value in mg of malonalehyde/kg of meat. A lower TBA value indicates better oxidative stability of the product.

### Microbiological Evaluation

A sample of the meat product was weighed into a sterile bag. An appropriate amount of diluent (sterile 0.9% NaCL) was added and the sample was homogenized. One ml of sample was transferred to the centre of RIDA® COUNT Total plate. The plate was incubated at a temperature of 35° C.±1° C. for 48 hours (±2 hours) and colonies were counted after incubation.

### Example 1

Rosemary extract containing 20% (w/w) of camosic acid was mixed with a green tea extract containing 50% of epigallocatechin-gallate. The mixture was supplemented with edible salt and silicon dioxide to improve the flowability and inhibit the caking. The synergistic mixture (MIXTURE 1) was intimately blended and ground. The final concentration of the active components in the mixture was 2% (w/w) of camosic acid and 5% (w/w) of epigallocatechin-gallate.

Fresh beef meat having a temperature 0 to 2° C. was ground in a meat grinder. Rosemary extract, green tea extract and the above MIXTURE 1, in the concentrations of 0.005% (w/w), 0.01% (w/w), 0.02% (w/w), 0.05% (w/w), 0.1% (w/w), and 0.15% (w/w), were mixed into ground beef meat. At the same time, samples were prepared with the addition of 0.05% of ascorbic acid and 0.05% of sodium ascorbate, and a sample without the addition of antioxidant (CONTROL). The meat was stored in a refrigerator at 2° C. and after 5 days the isolated fats were subjected to the Rancimat test and TBA number measurement by means of distillation method.

The Rancimat test conductometrically measured the obtained oxidation products of unsaturated fatty acids. The result is expressed as the induction time, i.e., the time, in which the peroxide number attains the value of 100 micro eq/kg of fat. The longer the induction time, the more stable is the product.

Into a test tube were weighted 3 g of fat. The cell was heated to 100° C., and air was blown into the sample to accelerate the oxidation. The easily volatile oxidation products were dissolved in water and thus modified the water conductivity. The latter showed a steep rise after the cessation of the induction phase.

10 g of meat or meat product were macerated with 50 ml of water for 2 minutes and the mixture was washed into a distillation flask with 47.5 ml of distilled water. To the mixture were added 2.5 ml of 4 N HCl, an antifoaming agent, and boiling pebbles. The flask was heated until 50 ml of the distillate were collected. 5 ml of the distillate were pipetted into a test tube fitted with a ground stopper, and there were added 5 ml of 0.2883% (w/v) of the solution of TBA in 90% glacial acetic acid. The test tube was tightly closed, the contents were mixed, and heated in boiling water for 35 minutes. The reference sample was prepared in the same manner, except that 5 ml of distilled water was pipetted into the test tube instead of the distillate. The sample and the reference sample were cooled after incubation, and the absorbance (D) was measured at 538 nm. The TBA number represents the amount (in mg) of malone aldehyde (MDA) per kg of the sample, and is equal to the 7.8-fold absorbance (D). The lower the TBA number, the more stable is the product.

The sample supplemented with 0.1% (w/w) (20 mg/kg of carnosic acid, 50 mg/kg of epigallocatechin-gallate) of the mixture MIXTURE 1, had a 2.5-fold longer induction time in comparison with the sample supplemented with 0.01% (w/w) (20 mg/kg of camosic acid) of the rosemary extract, and a 2.7-fold longer induction time than the sample supplemented with 0.01% of the green tea extract (50 mg/kg of epigalocatechin-gallate).

The sample supplemented with 0.1% (w/w) (20 mg/kg of carnosic acid, 50 mg/kg of epigallocatechin-gallate) of the mixture MIXTURE 1, had a 1.5-fold lower TBA number in comparison with the sample supplemented with 0.01% (w/w) (20 mg/kg of carnosic acid) of the rosemary extract, and a 1.7-fold lower TBA number than the sample supplemented with 0.01% of the green tea extract (50 mg/kg of epigalocatechin-gallate).

At the same time, the sample supplemented with 0.1% (w/w) of the mixture MIXTURE 1 retained its pink color and meat freshness.

A microbiological analysis of the samples consisting of ground beef meat was performed after 3 and 5 days storage in a refrigerator. The MIXTURE 1 gave after three days storage at a temperature of 2° C. a 20% better microbiological image than the rosemary extract and the green tea extract.

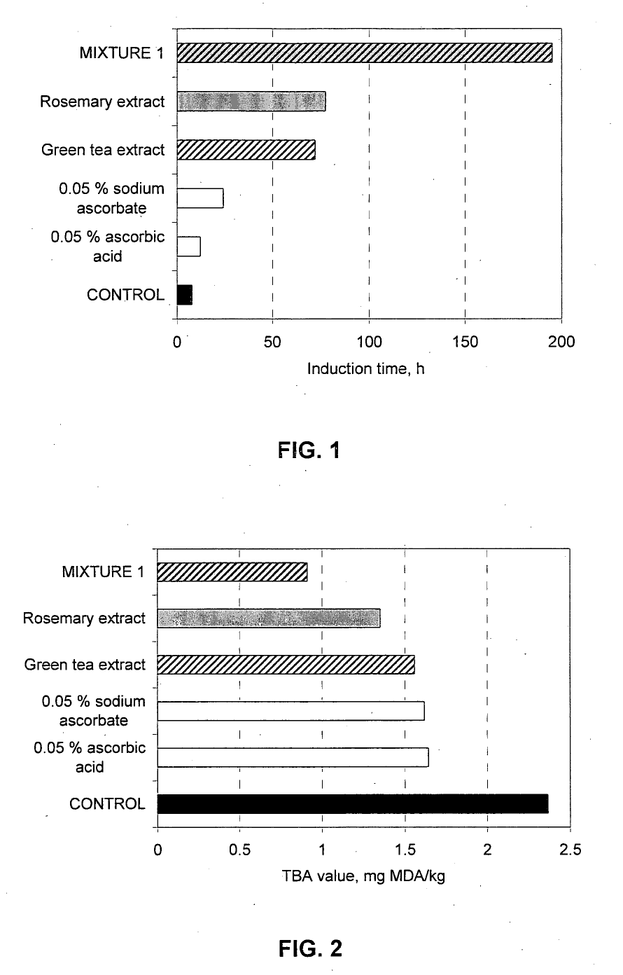

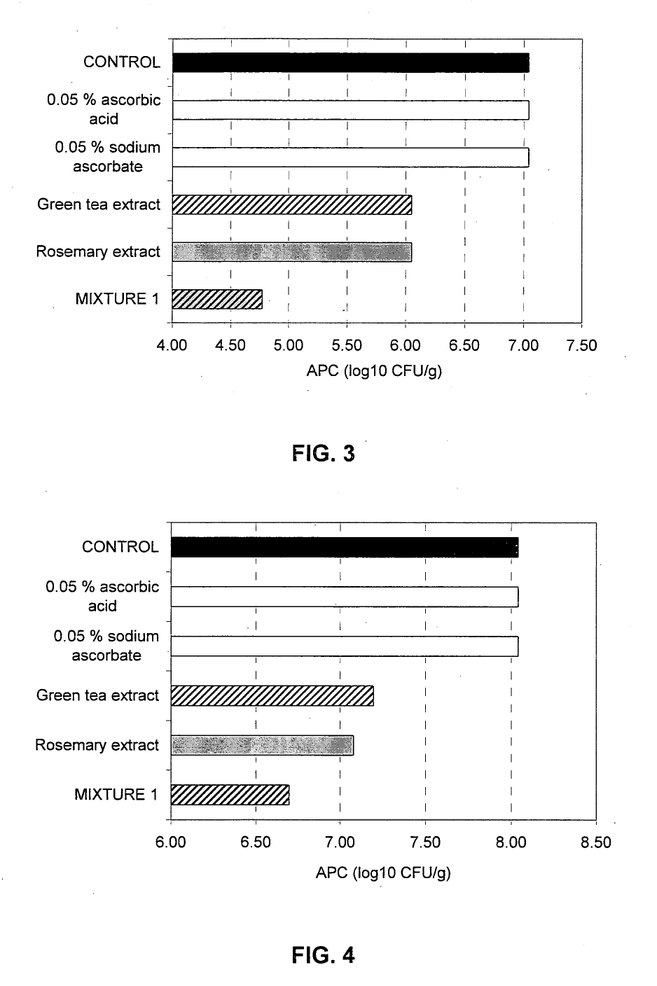

The results of this example are further clarified with reference to FIGS. 1-4.

### Example 2

Rosemary extract containing 20% (w/w) of carnosic acid was mixed with a green tea extract containing 50% of epigallocatechin-gallate so that final formulation contains 5% CA and 2% EGCG.

The mixture was supplemented with edible salt and silicon dioxide to improve the flowability and inhibit the caking. The synergistic mixture (MIXTURE 2) was intimately blended and ground. The final concentration of the active components in the mixture was 5% (w/w) of carnosic acid and 2% (w/w) of epigallocatechin-gallate.

Fresh beef meat having a temperature 0 to 2° C. was ground in a meat grinder. Rosemary extract, green tea extract and the above MIXTURE 2, in the concentrations of 0.004% (w/w), 0.005% (w/w), 0.01% (w/w), 0.025% (w/w), 0.05% (w/w), 0.1% (w/w), and 0.15% (w/w), were mixed into ground beef meat. At the same time, samples were prepared with the addition of 0.05% (w/w) of ascorbic acid and 0.05% (w/w) of sodium ascorbate, and a sample without the addition of antioxidant (CONTROL). The meat was stored in a refrigerator at 2° C. and after 5 days the isolated fats were subjected to the Rancimat test, and TBA number was measured by means of distillation method.

The sample supplemented with 0.1% (w/w) (50 mg/kg of carnosic acid, 20 mg/kg of epigallocatechin-gallate) of the mixture MIXTURE 2, had a 2.1-fold longer induction time in comparison with the sample supplemented with 0.025% (w/w) (50 mg/kg of carnosic acid) of the rosemary extract, and a 2.3-fold longer induction time than the sample supplemented with 0.004% of the green tea extract (20 mg/kg of epigalocatechin-gallate).

The sample supplemented with 0.1% (w/w) (50 mg/kg of carnosic acid, 20 mg/kg of epigallocatechin-gallate) of the mixture MIXTURE 2, had a 1.3-fold lower TBA number in comparison with the sample supplemented with 0.025 (w/w) (50 mg/kg of carnosic acid) of the rosemary extract, and a 1.9-fold lower TBA number than the sample supplemented with 0.004% of the green tea extract (20 mg/kg of epigalocatechin-gallate).

At the same time, the sample supplemented with 0.1% (w/w) of the mixture MIXTURE 2 retained its pink color and meat freshness.

A microbiological analysis of the samples consisting of ground beef meat was performed after 3 and 5 days storage in a refrigerator. The MIXTURE 2 gave after three days storage at a temperature of 2° C. a 15% better microbiological image than the rosemary extract and the green tea extract.

### Example 3

Rosemary extract containing 20% (w/w) of carnosic acid was mixed with a green tea extract containing 50% of epigallocatechin-gallate. The mixture was supplemented with edible salt and silicon dioxide to improve the flowability and inhibit the caking. The synergistic mixture (MIXTURE 1) was intimately blended and ground. The final concentration of the active components in the mixture was 2% (w/w) of carnosic acid and 5% (w/w) of epigallocatechin-gallate.

Fresh beef and pork meats were cooled to −4° C. The ingredients for the manufacture of dried salami sausages were introduced into the meat mincer in the following sequence: bacon, the first portion of the beef and pork meat mixture, spices (seasoning), additives, starter cultures, the second portion of the beef and pork meat mixture, and nitrite salt. Rosemary extract, green tea extract and the above MIXTURE 1, in the concentrations of 0.005% (w/w), 0.01% (w/w), 0.02% (w/w), 0.05% (w/w), 0.1% (w/w), and 0.15% (w/w), were mixed into the ground meat paste. At the same time, samples were prepared with the addition of 0.05% (w/w) of ascorbic acid and 0.05% (w/w) of sodium ascorbate, and a sample without the addition of antioxidant (CONTROL). The salami sausages were cold smoked at a temperature up to 25° C. for 3 hours, and cured in a special chamber at controlled temperature, air circulation and humidity (%). The parameters were checked daily. After fermentation and dehydration, the products were ready for use. The salami sausages were stored at 4° C. After 150 days the isolated fats were subjected to the Rancimat test, and their TBA number was measured by means of distillation method.

The sample supplemented with 0.1% (w/w) (20 mg/kg of carnosic acid, 50 mg/kg of epigallocatechin-gallate) of the mixture MIXTURE 1, had a 2.6-fold longer induction time in comparison with the sample supplemented with 0.01% (w/w) (20 mg/kg of carnosic acid) of the rosemary extract, and a 22-fold longer induction time than the sample supplemented with 0.01% of the green tea extract (50 mg/kg of epigalocatechin-gallate).

The sample supplemented with 0.1% (w/w) (20 mg/kg of carnosic acid, 50 mg/kg of epigallocatechin-gallate) of the mixture MIXTURE 1, had a 3.5-fold lower TBA number in comparison with the sample supplemented with 0.01 (w/w) (20 mg/kg of carnosic acid) of the rosemary extract, and a 4.4-fold lower TBA number than the sample supplemented with 0.01% of the green tea extract (50 mg/kg of epigalocatechin-gallate).

At the same time, the sample supplemented with 0.1% (w/w) of the mixture MIXTURE 1 retained its pink color and meat freshness.

A microbiological analysis of the salami sausage samples was performed after 150 days storage at 4° C. The MIXTURE 1 gave a 24% better microbiological image than the rosemary extract, and a 40% better result than the green tea extract.

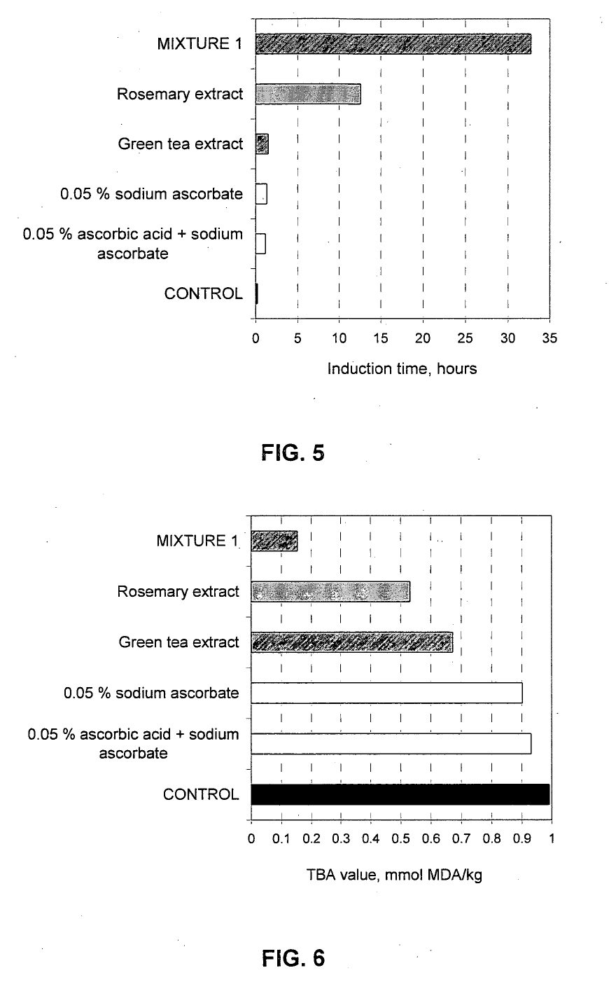

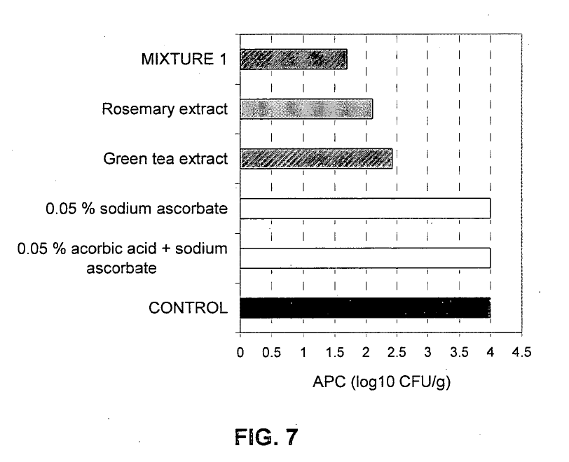

The results of this Example are further clarified with reference to FIGS. 5-7. The above Examples relate also to extracts made of other plants of the Labiatae family such as sage, melissa, oregano, savory, mint, thyme and others.

Although embodiments of the invention have been described by way of illustration, it will be understood that the invention may be carried out with many variations, modification, and adaptations, without departing from its spirit or exceeding the scope of the claims.

1. A mixture for the antioxidative and microbiological protection of fats and foodstuffs comprising fats, wherein the mixture comprises the extract of at least one plant chosen from the Labiatae family, and green tea extract having a synergistic effect and wherein the mixture further comprises at least one distribution enhancing agent.

2. (canceled)

3. The mixture according to claim 1, wherein the distribution enhancing agent is silicone dioxide.

4. The mixture according to claim 1, further comprising edible salt, maltodextrin, dextrose, or any suitable carrier or emulsifier allowed in the food processing industry.

5. (canceled)

6. The mixture according to claim 1, wherein the foodstuff comprising fats is meat or meat products.

7. The mixture according to claim 1, wherein the foodstuff comprising fats is fish or fish products.

8. Fats or foodstuff comprising fats, comprising a mixture of the extract of at least one plant chosen from the Labiatae family, green tea extract and at least one distribution enhancing agent.

9. (canceled)

10. The fats or foodstuff comprising fats according to claim, wherein mixture comprises carnosic acid, rosmarinic acid, or epigallocatechin-gallate, and wherein the concentration of carnosic acid, rosmarinic acid, or epigallocatechin-gallate, in the fats or foodstuff comprising fats is at least 1 ppm.

11. The fats or foodstuff comprising fats according to claim 8, wherein said foodstuff comprising fats is meat or meat products.

12. The fats or foodstuff comprising fats according to claim 8, wherein said foodstuff comprising fats is fish or fish products.

13. The fats or foodstuff comprising fats according to claim 8, wherein said fats or foodstuff comprising fats retain their color, texture, flavor and fresh odor.

14. A method for protecting fats and foodstuffs from oxidation and microbes by contacting the foodstuff or fats with a mixture comprising an extract of at least one plant chosen from the Labiatae family, and a green tea extract, wherein the at least one plant chosen from the Labiatae family, and green tea extract has a synergistic effect and wherein the mixture further comprises at least one distribution enhancing agent.

15. (canceled)
